(19) United States
(12) Patent Application Publication
(10) Pub. No.: US 2016/0004757 A1
(43) Pub. Date: Jan. 7, 2016

(54) DATA MANAGEMENT METHOD, DATA MANAGEMENT DEVICE AND STORAGE MEDIUM

(71) Applicant: HITACHI, LTD., Chiyoda-ku, Tokyo (JP)

(72) Inventors: Masashi TSUCHIDA, Tokyo (JP); Takashi KOTERA, Tokyo (JP); Kentarou CHIGUSA, Tokyo (JP); Shohei MATSUURA, Tokyo (JP); Yukio NAKANO, Tokyo (JP)

(73) Assignee: Hitachi, Ltd., Chiyoda-ku, Tokyo (JP)

(21) Appl. No.: 14/770,018

(22) PCT Filed: Oct. 4, 2013
(86) PCT No.: PCT/JP2013/077141

§ 371 Date: Aug. 24, 2015

(51) Int. Cl. G06F 17/30

(52) U.S. Cl. CPC G06F 17/30563; G06F 17/30592; G06F 17/30539; G06F 17/30604; G06F 17/30598; G06F 17/30339

(57) ABSTRACT

A data management method employing the results of an analysis of data stored in a storage unit of a computer provided with a processor and a storage unit, wherein the computer generates an analysis data set by selecting data stored in the storage unit, subjects the analysis data set to prescribed data mining, extracts a model from the analysis data set, converts the model into a relational table, and associates the relational table with a dimension table and a history table that have been stored in advance in the storage unit.

### BACKGROUND

The present invention relates to a technique of using information attained by data mining in an existing application.

In the real world surrounding us, as a result of the development of the Web, a large amount of data transmitted on the basis of the behavior of people and data transmitted on the basis of movement of objects has been generated. There are many cases in which such data is condensed and data analysis methods for understanding trends have not been determined in advance. As a result, there is a need for methods to obtain rules to understand data and construct models through trial and error.

Data mining is a method for extracting rules from data and constructing models, and specifically, an object thereof is to “extract, from a large amount of data, unknown rules, and unknown models, that is, new information that cannot be obtained by human observation alone.” Non-Patent Document 2 and Non-Patent Document 3 are known examples of data mining. Non-Patent Document 1 is known as a technique for analyzing data stored in a database.

### RELATED ART DOCUMENTS

Non-Patent Document 1: “Oracle Database Data Warehousing Guide,” [online], [searched on Aug. 1, 2013], Internet <URL:
   http://docs.oracle.com/cd/B28359_{—}01/server.111/b28313/schemas.htm>
Non-Patent Document 2: “IBM SPSS Modeler 14.2 User's Guide,” [online], [searched on Aug. 1, 2013], Internet <URL: http://faculty.smu.edu/tfomby/eco5385/data/SPSS/SPSS%20Modeler_{—}14_{—}2_UsersGuide.pdf>
Non-Patent Document 3: Han, J., Kamber, M., and Pai, J., “Data Mining: Concepts and Techniques, Third Edition,” Morgan Kaufmann Publishers (2011).

### SUMMARY

In recent years, there is increasing demand for using information (rules or models) or knowledge obtained by analysis in data mining, and finding the overall picture of other data, the relationship between data, or underlying structures.

However, in order to combine information obtained by data mining with online analytical processing (OLAP) of an information system owned by a company or with data analysis such as statistical analysis, or to combine information obtained by data mining with business applications on enterprise systems, the information must be processed individually at the level of each application. Thus, in order to apply information obtained by data mining or the like to existing enterprise systems or information systems, it is necessary to add and modify complex data processes such as data modeling and data processing for each application, which requires a large amount of work.

The present invention takes into account the above-mentioned problem, and an object thereof is to apply information obtained by data mining or the like to existing enterprise systems and information systems with ease. A representative aspect of the present disclosure is as follows. A data management method using results of analyzing data stored in a storage module by a computer comprising a processor and the storage module, the data management method comprising: a first step of selecting, by the computer, data stored in the storage module, and generating, a data set for analysis; a second step of performing, by the computer, prescribed data mining on the data set for analysis, and extracting, a model from the data set for analysis; a third step of converting, by the computer, the model to a relational table; and a fourth step of associating, by the computer, with a dimension table and a history table stored in advance in the storage module in association with the relational table.

According to the present invention, it is possible to use models extracted by data mining without modifying existing business applications. Also, it is possible to extract models by performing analysis and evaluation repeatedly on the same data set for analysis using different parameters.

### BRIEF DESCRIPTION OF THE DRAWINGS

FIG. 1 is a block diagram showing one example of a data management device of an embodiment of this invention

FIG. 2 is a schematic view showing an example of a process performed by the data management device of an embodiment of this invention.

FIG. 3 is a block diagram indicating a relation between the database, the data warehouse, the data set for analysis, and the model of an embodiment of this invention.

FIG. 4 is a flowchart showing one example of a process performed in an information system and an enterprise system of an embodiment of this invention.

FIG. 5 shows an example of clustering performed by the data mining module of the data management device of an embodiment of this invention.

FIG. 6 shows an example of a decision tree executed by the data mining module of the data management device of an embodiment of this invention.

FIG. 7 is an example of the definition of the star schema of an embodiment of this invention.

FIG. 8 shows the relation between data when generating the star schema of an embodiment of this invention.

FIG. 9 is a flowchart showing an example of the table definition process performed by the data management device of an embodiment of this invention.

FIG. 10 is a flowchart showing an example of a process performed by the data loading processor of the data management device of an embodiment of this invention.

FIG. 11 shows an example of the clustering results being added to the data warehouse of an embodiment of this invention.

FIG. 12 shows an example of the data set for analysis selected by the data selection module of an embodiment of this invention.

FIG. 13 shows an example of a relational table of an embodiment of this invention.

FIG. 14 is a flowchart showing one example of a process performed by the data management device in which the clustering results are converted to the relational table of an embodiment of this invention.

FIG. 15 shows an example of the decision tree being obtained by extracting the decision tree from the data set for analysis of an embodiment of this invention.

FIG. 16 shows an example of the data set for analysis of an embodiment of this invention.

FIG. 17 is a schematic view showing an example of a prediction process performed by the data management device of an embodiment of this invention.

FIG. 18 is a descriptive drawing showing another example of a prediction process performed by the data management device of an embodiment of this invention.

FIG. 19 is a flowchart showing an example of the prediction process performed by the data management device of an embodiment of this invention.

### DETAILED DESCRIPTION OF EMBODIMENTS

Hereinafter, embodiments for carrying out the present invention will be described in detail with reference to accompanying drawings.

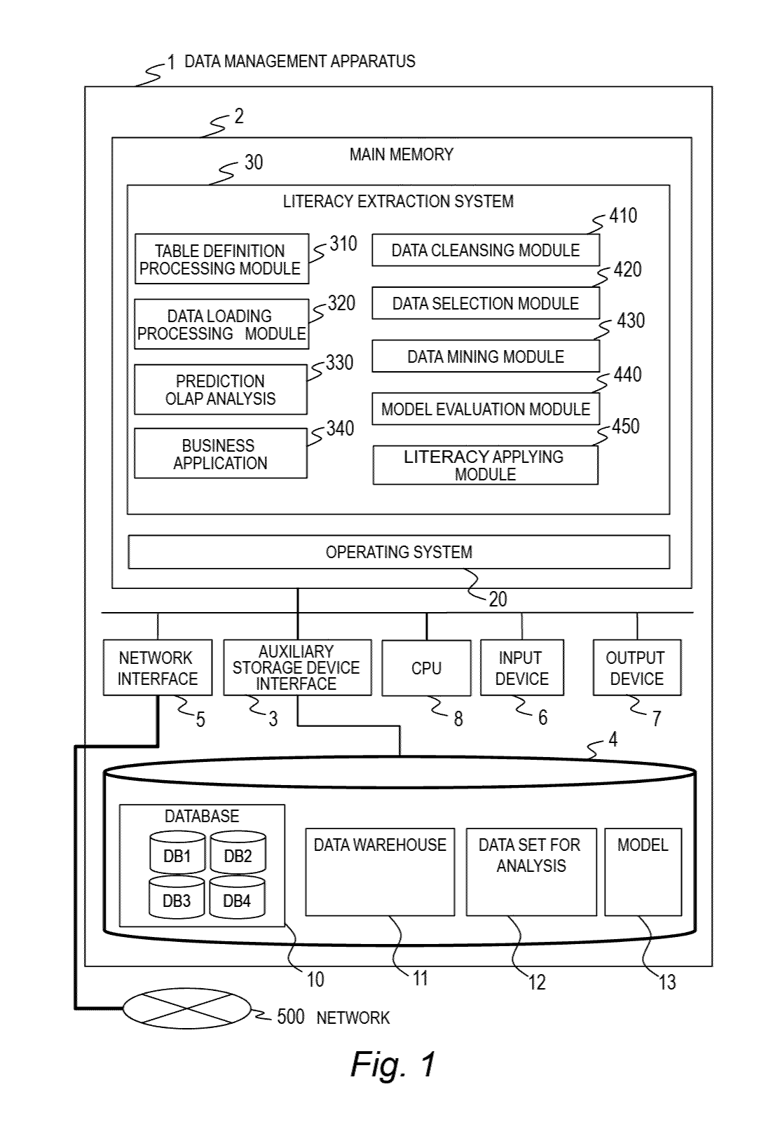

FIG. 1 is a block diagram showing an example of a data management device of an embodiment of the present invention. A data management device 1 obtains new information by performing data mining on data selected from a database 10 as a business application comprising an enterprise system, and executes a literacy extraction system 30 that causes the new information to be added to a business application 340 and a data warehouse 11.

The data management device 1 is a computer comprised of a CPU 8 that performs calculations, a main memory 2 that stores data and programs, an auxiliary storage device 4 that stores the database 10 and programs, a network interface 5 that allows communication with the network 500, an auxiliary storage device interface 3 that reads from and writes to the auxiliary storage device 4, input devices 6 including a keyboard and a mouse, and output devices 7 including displays, speakers, and the like.

In the main memory 2, an operating system (OS) 20 is loaded and executed by the CPU 8. In the OS 20, new literacy is obtained on the basis of data in the database 10 and the data warehouse 11, and a literacy extraction system 30 that adds this new information to the business application 340 and the data warehouse 11 operates.

The literacy extraction system 30 is comprised of an enterprise system and an information system. The enterprise system is comprised of the business application 340 and a prediction OLAP analysis 330. The business application 340 is comprised of a database management system (DBMS) that manages the database 10, for example. DB1-DB4 in the drawing are databases for each operation.

Meanwhile, the information system includes a table definition processing module 310, a data loading processing module 320, a data cleansing module 410, a data selection module 420, a data mining module 430, a model evaluation module 440, and an literacy applying module 450 as processors. The prediction OLAP analysis 330 may be used in the information system.

As will be described later, in the information system, the data cleansing module 410 performs cleansing on data in the database 10, and stores the data in the data warehouse 11. The data selection module 420 selects data to be analyzed from among data stored in the data warehouse 11, and outputs the data set for analysis 12. Next, the data mining module 430 analyzes the data set for analysis 12 and extracts a model 13. Next, the model evaluation module 440 evaluates the model 13, and if it is useful literacy, then the model evaluation module 440 causes the new literacy to be added to the business application 340 using the literacy applying module 450. The data of the data warehouse 11 may be used from the enterprise system.

The CPU 8 is a functional module that realizes a prescribed function by executing a process according to programs in respective functional modules. For example, the CPU 8 functions as the table definition processing module 310 by executing a process according to a table definition program. The same applies for other programs. Additionally, the CPU 8 also operates as functional modules realizing, respectively, a plurality of processes executed by respective programs. The computer and the computer system are a device and system including these functional modules.

Programs, data, data structures, and the like realizing respective functions of the literacy extraction system 30 can be stored in a storage device such as the auxiliary storage device 4, a non-volatile semiconductor memory, a hard disk drive, or a solid state drive (SSD), or in a computer-readable non-transitory data storage medium such as an IC card, an SD card, or a DVD.

The auxiliary storage device 4 stores the database 10 having data to be analyzed, a data warehouse 11 storing data and the like that has been selected from the database 10 to be analyzed, a data set for analysis 12 to be subject to data mining, and a model 13, which is the result of data mining.

Although not shown, as described above, it is possible to store programs of the OS 20 and literacy extraction system 30 in the auxiliary storage device 4.

Also, in FIG. 1, an example is illustrated in which DB1 to Db4, which are comprised of relational databases (RDB), are stored in the database 10, but this database 10 is original data to be analyzed, and can be comprised of a duplication or a portion of external databases.

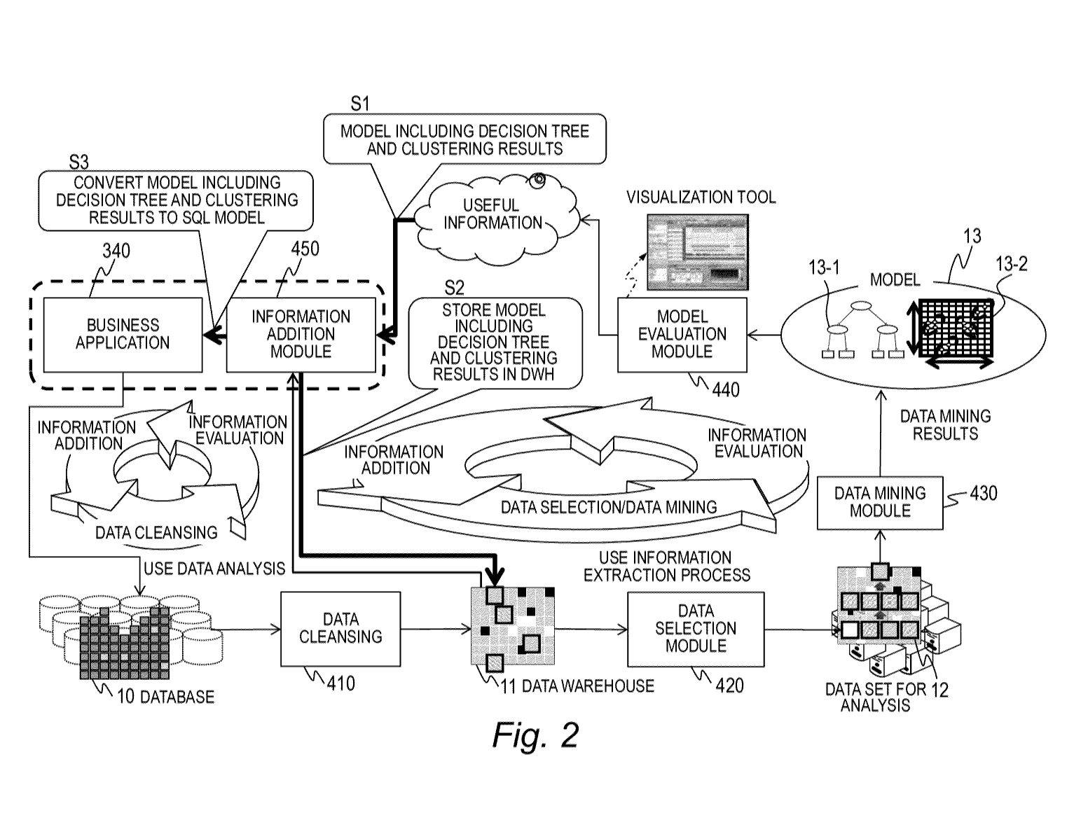

In the data management device 1 of the present invention, two processes are repeated: a process of extracting the model 13 from data in the database 10 using the data mining module 430, and obtaining the model 13 as new literacy (use of literacy extraction process of FIG. 2); and a process of applying the new literacy to the database 10 of the business application 340 (use of data analysis in FIG. 2). FIG. 2 is a schematic view showing an example of a process performed by the data management device. Below, a summary of the process performed by the data management device 1 of the present invention will be described with reference to FIG. 2.

First, the data cleansing module 410 performs data cleansing on the database 10 generated by the enterprise system. In the data cleansing module 410, erroneous or duplicate data is specified in the database 10, and this data is removed in order to maintain consistency in the database 10. The data in the database 10 that has been cleansed is stored in the data warehouse 11.

Next, the data selection module 420 selects data stored in the data warehouse 11 according to the purpose of the data mining, and generates a data set for analysis 12. Then, the data mining module 430 performs a prescribed data mining process on the data set for analysis 12, and extracts literacy such as unknown models. Examples of literacy include models 13 such as a decision tree 13-1 or clustering results 13-2. A well-known or publicly known data mining method may be used, and details thereof will not be given here.

In the model evaluation module 440, the model obtained by the data mining module 430 is displayed in a visualization tool, and is obtained as useful literacy according to human evaluation or calculation of an evaluation value. The visualization tool is software that displays data in graphs, tables, or the like. The model evaluation module 440 is not limited to human evaluation, and evaluation may be performed by using software that calculates an evaluation value for the model 13 and evaluates the model 13 as useful literacy according to the size of the evaluation value. The evaluation value differs depending on the data mining method, but cases will be shown in which the model is a cluster or a decision tree. If the model is a cluster, then because human evaluation of clustering results is qualitative and subjective, evaluation is performed according to the size of an entropy value of each cluster in the clustering results as a quantitative evaluation scale, a cohesion value of each cluster calculated using squared error, a separation value among clusters using the distance between centroids of two clusters, and the like. In the model is a decision tree, then the cross-validation method is used to calculate how reliably predictions can be made by a decision tree created by learned data, and the model is evaluated according to the prediction accuracy.

A model 13 comprised of the results of the model evaluation module 440 and decision tree or clustering results as useful literacy is extracted (S1). As useful literacy, the definition of the model 13 may be set as new literacy in addition to the model 13 comprised of the decision tree or clustering results.

Next, in the literacy applying module 450, literacy (model) obtained by the model evaluation module 440 is added to the data of the business application 340 and the data of the data warehouse 11.

The literacy applying module 450 for the business application 340 can apply new literacy to the database 10 of the business application 340 by converting the model 13 including the extracted decision tree and clustering results to an SQL model (S3). One method of converting the model 13 into an SQL model is, as described later, to obtain the decision tree by the data mining module 430 and express the decision tree or decision table in SQL.

Also, the literacy applying module 450 for the data warehouse 11 converts the model 13 including the extracted decision tree 13-1 and clustering results 13-2 into the relational table 14 and then stores the relational table 13 in the data warehouse (DWH) 11 (S2). The model 13 stored in the data warehouse 11 is added again to data mining and extraction of new literacy is performed. The relational table 14 can include clustering results, an SQL expression of a decision table, or an SQL expression of a decision tree, for example.

The literacy extraction process comprised of the steps above is repeated, and newly obtained literacy (model 13) is used in the business application 340 and the data warehouse 11, which means that a more sophisticated business analysis can be expected.

The user of the data management device 1 may determine whether the newly obtained literacy (model 13) is used by the business application 340 or by the data warehouse 11. After performing evaluation using the model evaluation module 440, a command can be received from an input device 6 indicating whether the model 13 is to be used by the business application 340 or the data warehouse 11, thereby allowing the user to determine whether the business application 340 or the data warehouse 11 is to use the model 13, for example.

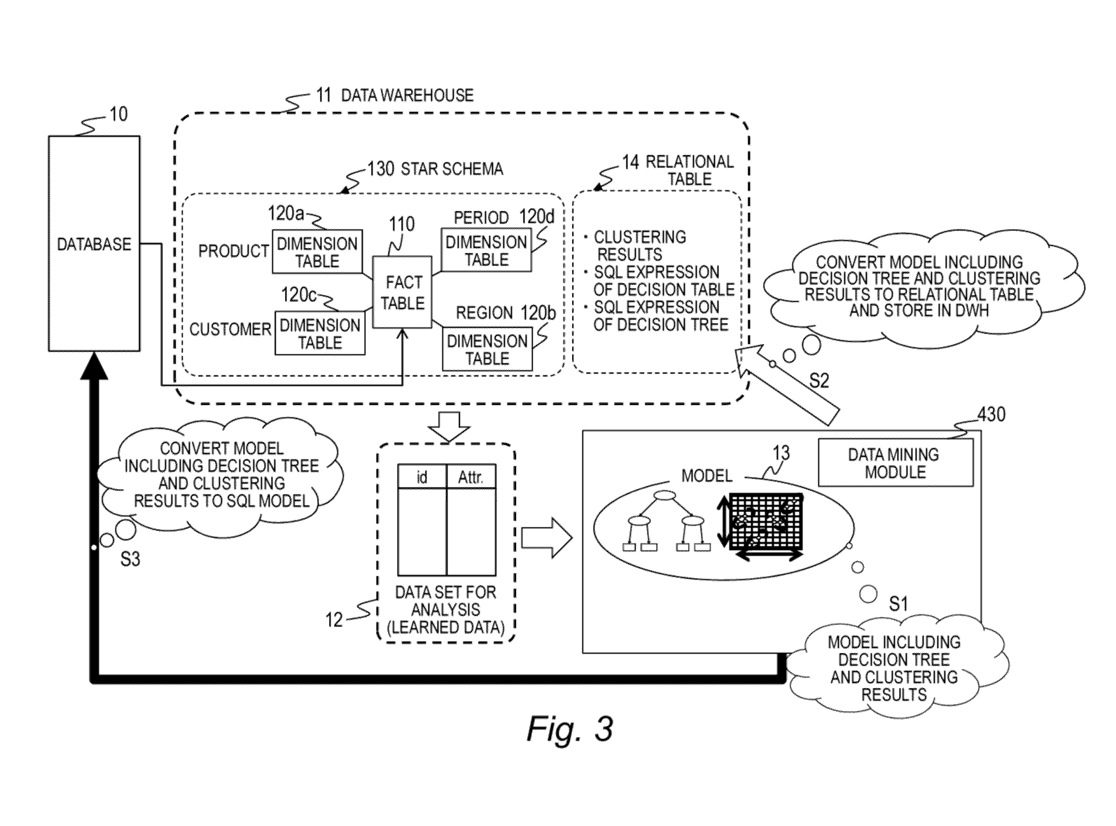

FIG. 3 is a block diagram indicating a relation between the database 10, the data warehouse 11, the data set for analysis 12, and the model 13. The data management device 1 configures a star schema 130 according to a preset definition.

In FIG. 3, an example is illustrated in which DB1 to DB4 (see FIG. 1), which are comprised of relational databases (RDB), are stored in the databases 10, but these databases 10 are original data to be analyzed, and can be comprised of a duplication or a portion of external databases.

Among the data of the database 10, data to be analyzed is sequentially extracted and used as a fact table 110 of the star schema 130.

The group of tables defined by the star schema 130 include the fact table 110 as original data of the database 10 and a plurality of dimension tables 120a to 120d defining data to be analyzed or aggregated. Below, the dimension tables will be collectively referred to as the database 10. The fact table 110 and the dimension tables 120 (120a to 120d) are associated with main keys.

In the example of FIG. 3, the structure of the star schema 130 includes dimension tables 120a to 120d for product, customer, period, and region, in relation to the fact table 110.

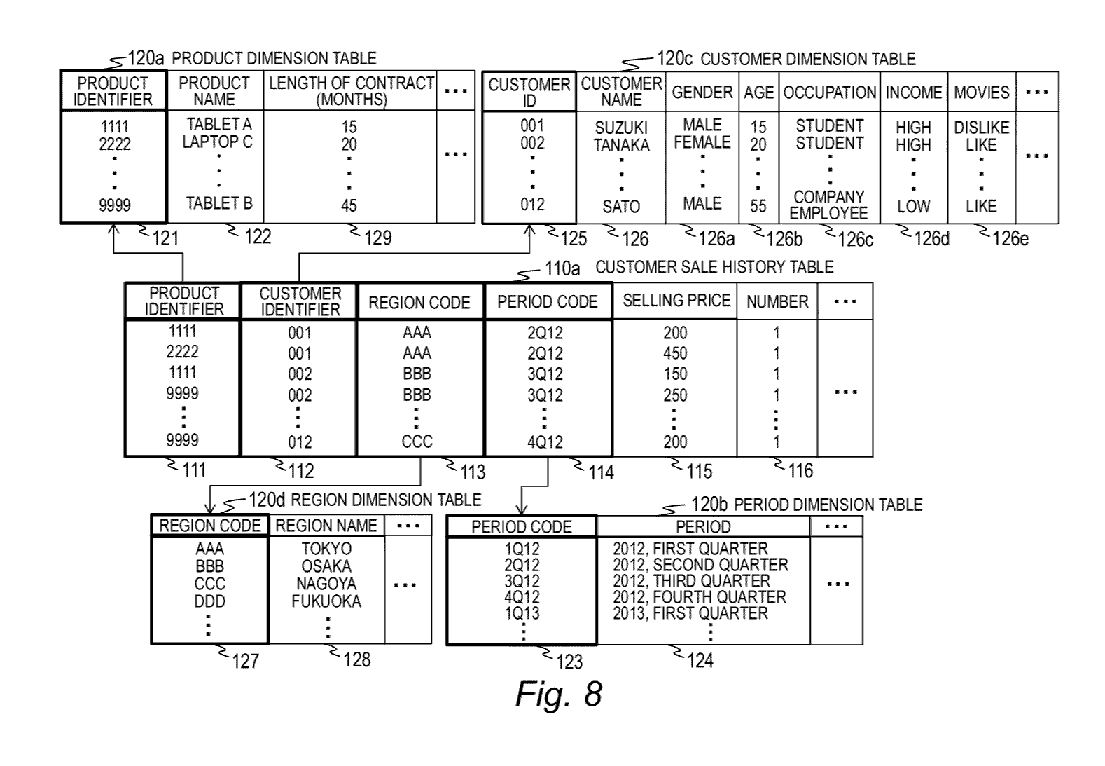

Thus, the dimension table 120a is a product dimension table relating to the product name (see FIG. 8), the dimension table 120b is a period dimension table relating to the period (see FIG. 8), the dimension table 120c is a customer dimension table relating to the customer (see FIG. 8), and the dimension table 120d is a region dimension table relating to the region name (see FIG. 8).

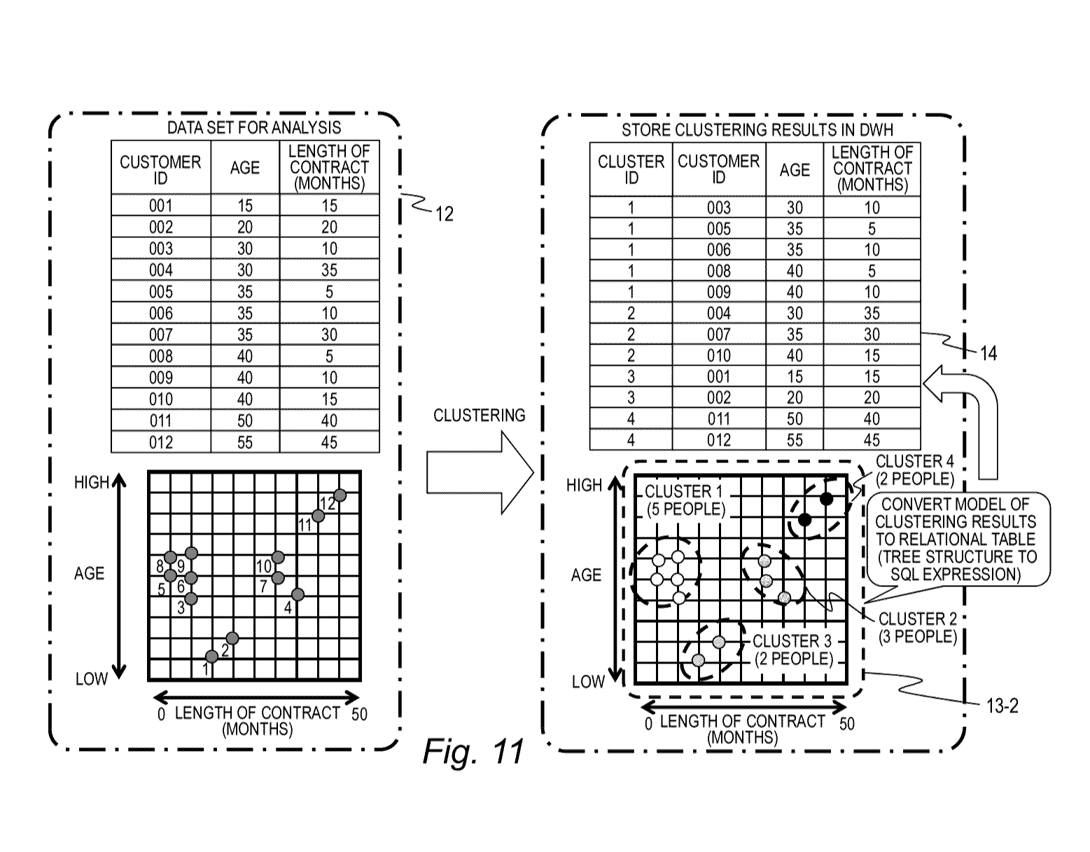

Also, data from the star schema 130 to be stored in the data warehouse 11 is selected according to the purpose of the data mining, and the data set for analysis 12 is generated (see FIGS. 11, 12, and 16).

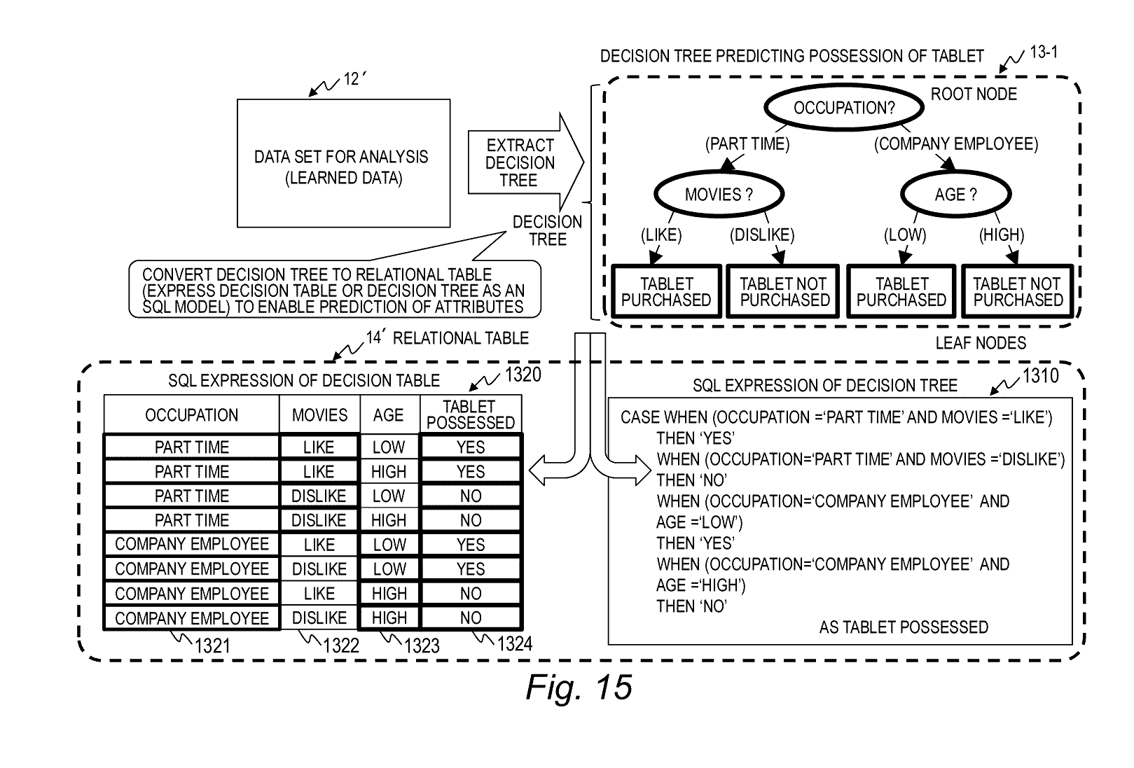

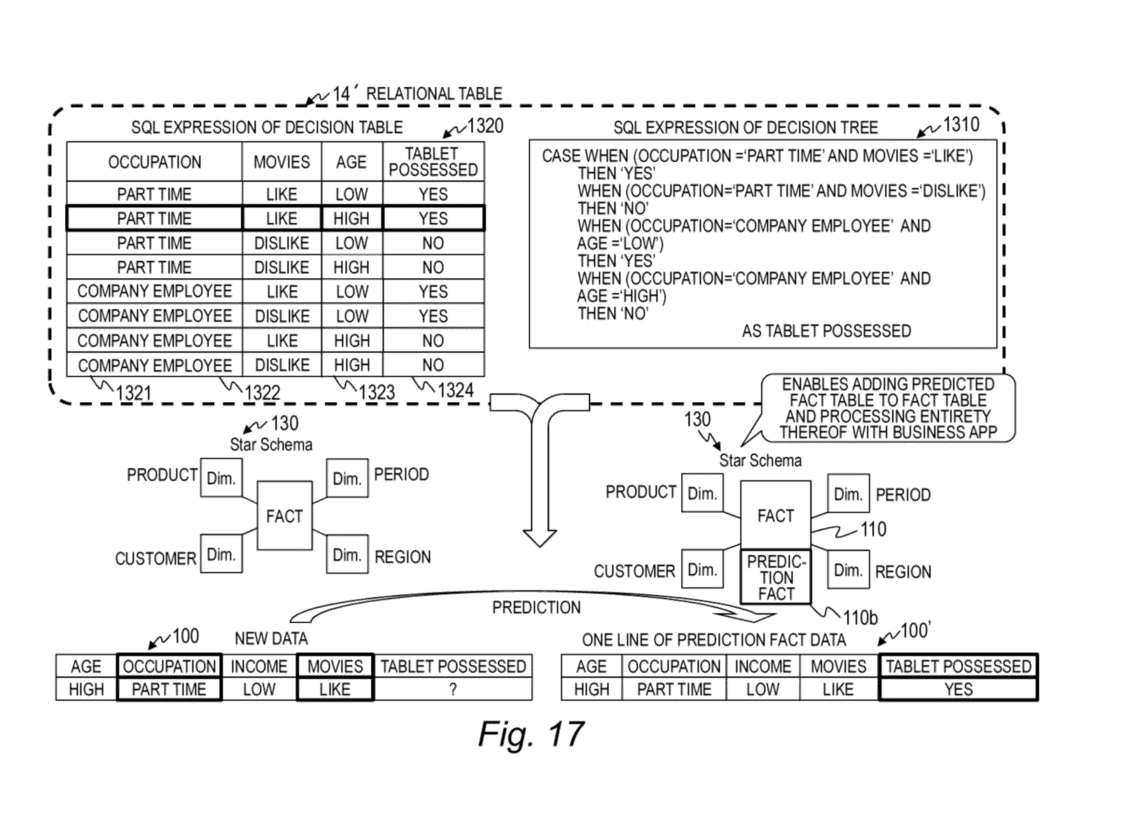

Additionally, the model 13 including the decision tree and clustering results extracted by the data mining module 430 is converted to a relational table 14 of clustering results (see FIGS. 11 and 13), or an SQL expression of the decision tree or decision table (see FIGS. 15 and 17).

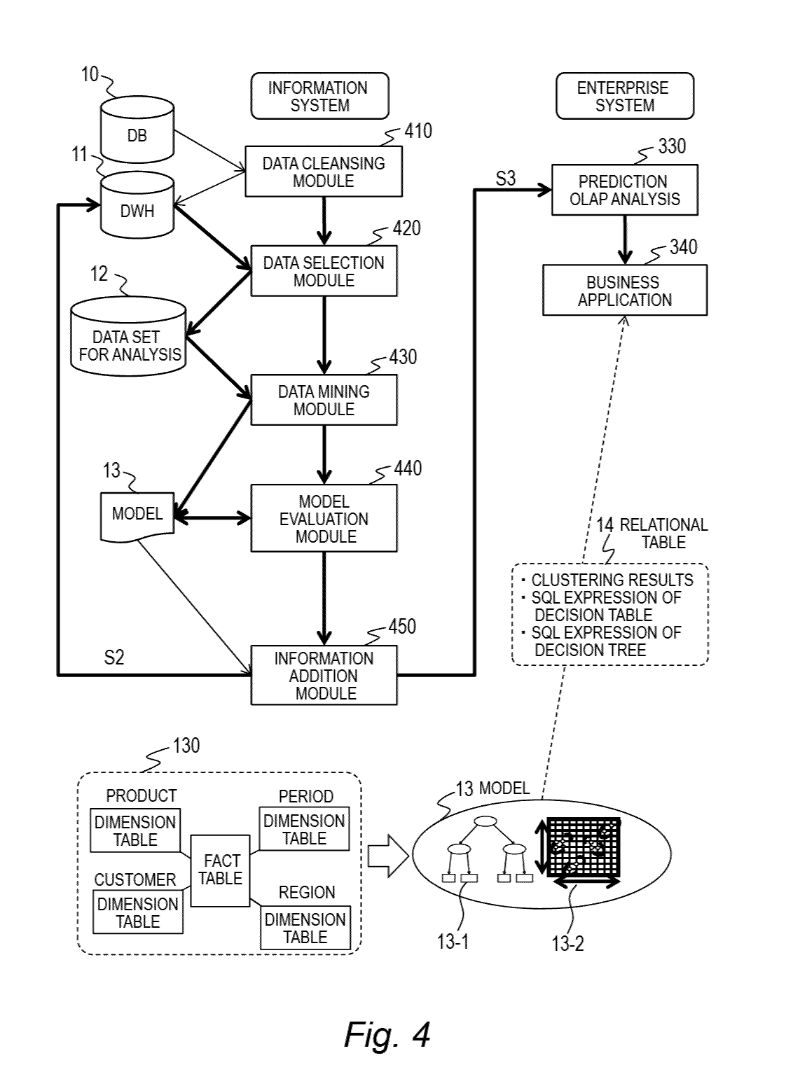

FIG. 4 is a flowchart showing one example of a process performed in an information system and an enterprise system. The data cleansing module 410 performs cleansing of data in the database 10. Data for which consistency was verified by the data cleansing module 410 is stored in the data warehouse 11 (DWH in the drawings).

In the data warehouse 11, the star schema 130 is configured from data of the database 10 on the basis of a preset definition 520 of the star schema.

Next, the data selection module 420 extracts, from the star schema 130 of the data warehouse 11, data to be analyzed as a data set for analysis 12 (learned data). The data set for analysis 12 is extracted by performing an inquiry such as association joining or aggregation on the plurality of dimension tables 120a to 120d and a history table (fact table 110) stored in the data warehouse 11.

The data mining module 430 performs data mining on the data set for analysis 12 extracted from the data warehouse 11, and obtains the model 13 such as the decision tree 13-1 and the clustering results 13-2. The decision tree 13-1 and the clustering results 13-2 are converted to the relational table 14.

The model evaluation module 440 displays in the output device 7 information obtained by the data mining module 430, or in other words, the model 13, such as the decision tree 13-1 and the clustering results 13-2, and the relational table 14 using a visualization tool, and obtains this literacy as useful literacy through human evaluation and interpretation. Evaluation of the model on the basis of the prediction OLAP analysis 330 may be performed by the model evaluation module 440.

Meanwhile, the literacy applying module 450 converts the clustering results obtained as mentioned above to an SQL model, and then to the relational table 14 (see FIGS. 11 and 13), and then stores the relational table 14 in the data warehouse 11 (S2). Then, data mining is performed again by a different method or with the use of different parameters.

If the obtained model 13 and relational table 14 are to be applied to the business application 340 of the enterprise system, then the relational table of the clustering results (see FIGS. 11 and 13) and the relational table 14 obtained by converting the decision tree or the decision table to an SQL expression (see FIGS. 15 and 17) are combined with the business application 340, the relational tables being obtained from the model 13 including the extracted decision tree and clustering results (S3). In this case, as described below, the model 13 is the decision tree 13-1 for performing predictions on attributes of new data using the prediction OLAP analysis 330.

In particular, the model evaluation module 440 creates the model 13 through trial and error by repeating analysis and evaluation with different categories and types. By defining category standards for income based on amount, the amount is converted to a category value of {high, low}, for example. The number of times a customer has accessed a website over a week is converted to a category defined as {low, mid, high}, with low being once, mid being 2 to 5 times, and high being 6 times or more. This type of data process is characterized in that analysis is repeated on the same data set for analysis 12 with different setting parameters for analysis such as data mining while changing the categories by trial and error.

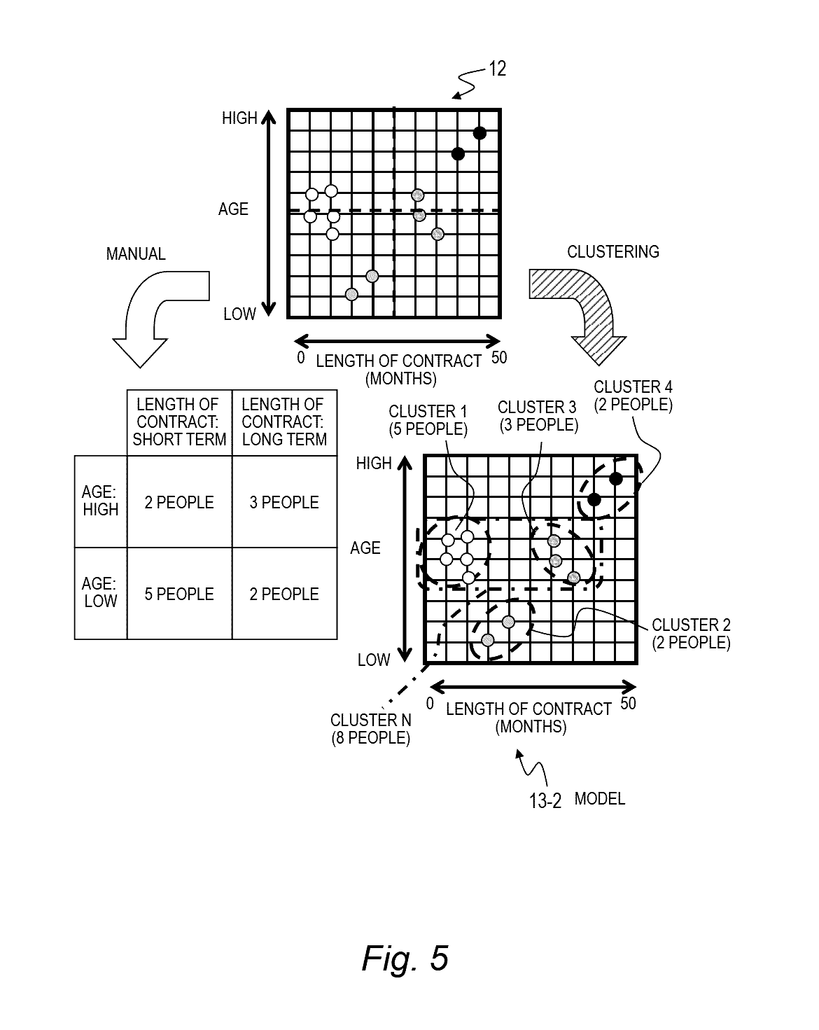

FIG. 5 shows an example of clustering performed by the data mining module 430 of the data management device 1. Clustering involves calculating the distance between members of the data set for analysis 12 in a population on the basis of defined attributes, and members are categorized by similarity according to the distance between data points.

FIG. 5 shows an example in which the data set for analysis 12 is data indicating the relation between the length of contract in months of a tablet and the age of the person who has signed the contract. “Manual” in the drawing indicates an example in which the data set for analysis 12 is categorized according to human experience or hypothesis. When categorized manually, it is possible to categorize the length of the contract as long or short, and the age of the person who has signed the contract as high or low, as shown in the drawing.

By contrast, if the model 13 is set as the clustering results 13-2 by the data mining module 430, then clusters that cannot be categorized by human experience or hypothesis can be extracted. In clusters 1 to 4, distances between data points of each cluster are close, and in addition, a cluster N can be seen in which the age group is within a prescribed range (where the people who signed the contracts are middle aged), and includes the clusters 1 and 3. In other words, by clustering, it is possible to obtain as the model the cluster N, which cannot be obtained by manual means.

By performing evaluation on the clustering results using the model evaluation module 440, it is possible to extract the middle aged group of the cluster N regardless of the length of the contracts, and it is possible to obtain literacy such as that for proposing business strategies for the middle aged group comprising the two clusters 1 and 3 included in the cluster N.

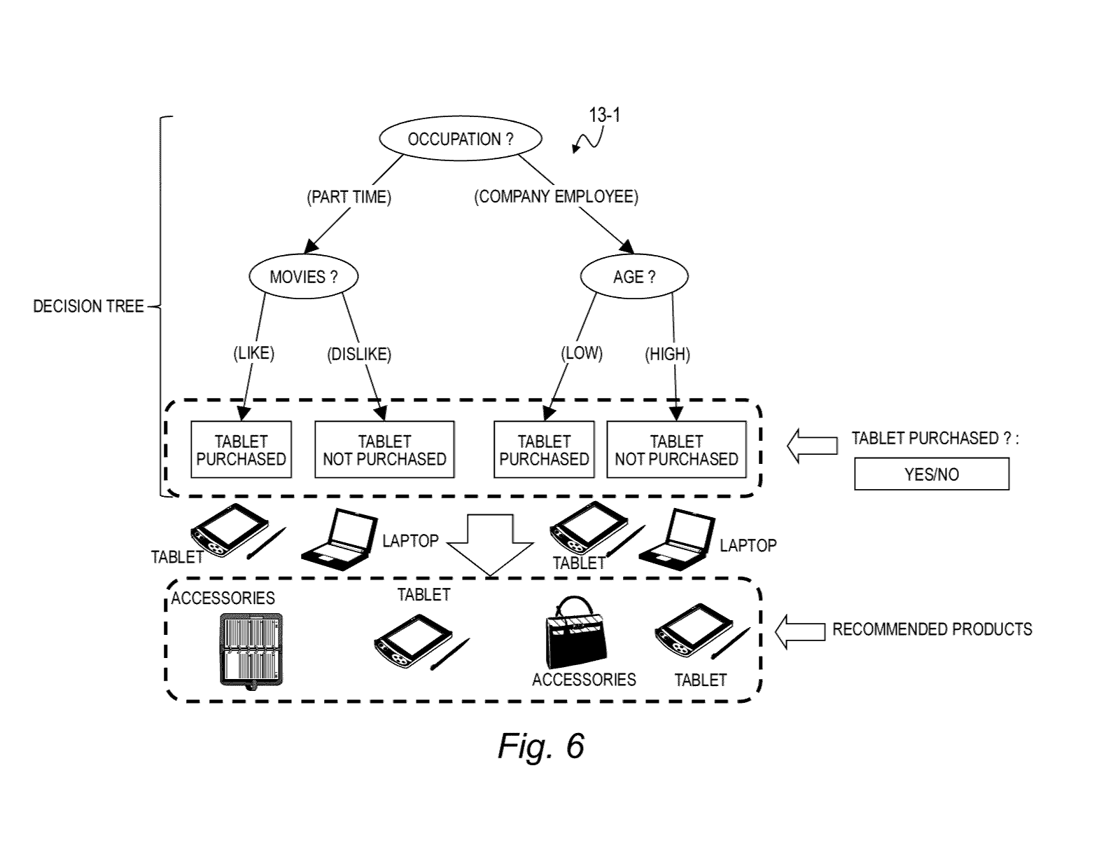

FIG. 6 shows an example of a decision tree 13-1 executed by the data mining module 430 of the data management device 1. The decision tree 13-1 is generated from past data and is a model to make predictions on new data. In the decision tree 13-1 shown in the drawing, recommended products are predicted on the basis of a person's occupation, age, tastes (like or dislike or movies), and whether or not the person has purchased a tablet. A user or the like of the data management device 1 sets the recommended products.

By using the above decision tree 13-1 on new customer data, it is possible to predict the best products for each new customer.

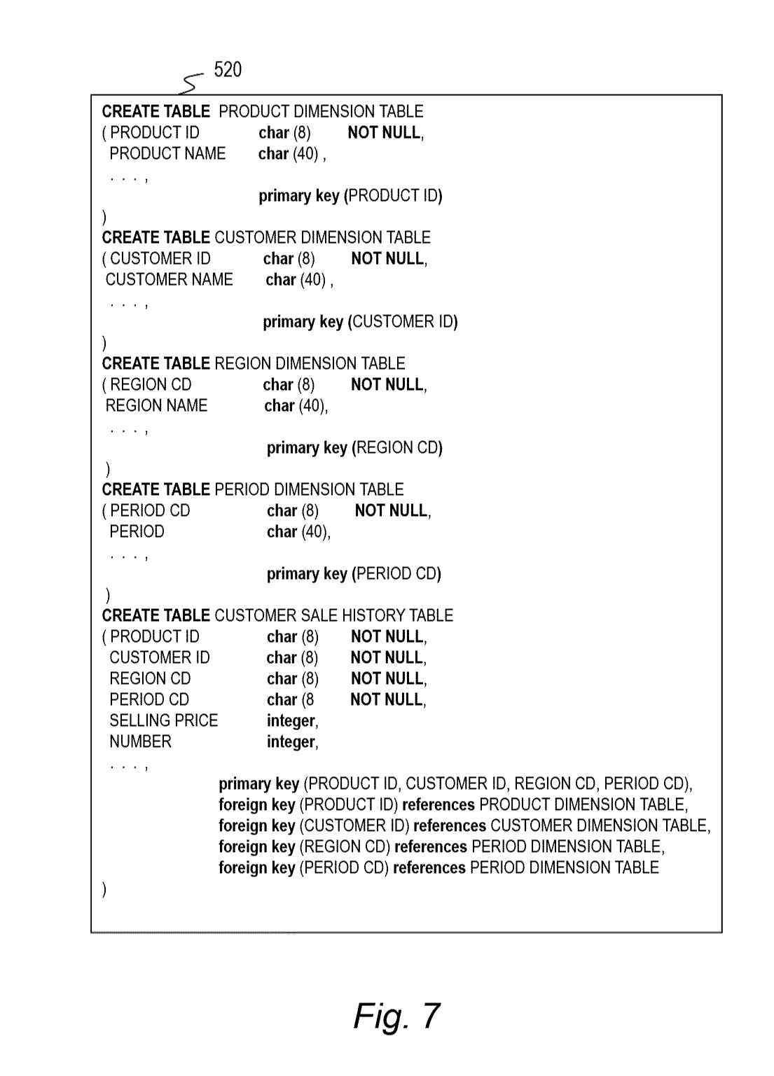

Next, an example of data that generates the star schema 130 is shown in FIGS. 7 and 8.

FIG. 7 is an example of the definition 520 of the star schema 130. In the table definition processing module 310, the definition 520 of the star schema 130 of FIG. 7 is read in, and the fact table (customer sale history table 110a) and the dimension tables 120a to 120d shown in FIG. 8 are generated.

The definition 520 includes definitions of the plurality of dimension tables 120a to 120b indicating the meaning of data in the database 10, and a definition of a history table (fact table) storing the data of the database 10 as one-dimensional sequential data.

FIG. 8 shows the relation between data when generating the star schema. FIG. 8 shows an example of generating the dimension tables 120 and the fact table 110 (customer sale history table 110a) from the sale database of the database DB1 included in the database 10 shown in FIG. 1. This process is performed in the table definition processing module 310 of the literacy extraction system 30 shown in FIG. 1. In the present embodiment, an example is shown in which the customer sale history table 110a is generated as the fact table 110.

The table definition processing module 310 generates the customer sale history table 110a from the sale database of the database DB1. The customer sale history table 110a is comprised of one record (or row) including a product identifier 111 for products sold, a customer identifier 112 for customers who have purchased such products, a region code 113 for regions where such products were sold, a period code 114 storing a period when such products were sold, a selling price 115 storing the price of products sold, and a number 116 of products sold. In the present embodiment, the product identifier 111, the customer identifier 112, the region code 113, and the period code 114 of the customer sale history table 110a are handled as main keys including a plurality of identifiers, and the selling price 115 and the number 116 are handled as attributes.

Next, the table definition processing module 310 generates from the database 10 the product dimension table 120a having as the main key the product identifier 111 of the customer sale history table 110a. The product dimension table 120a is comprised of one record (or row) including the product identifier 121 as the main key, a product name 122, and a contract length 129 in months. In the present embodiment, the product identifier 121 is handled as an identifier associated with the product identifier 111 of the customer sale history table 110a, and the product name 122 is handled as an attribute.

Next, the table definition processing module 310 generates from the database 10 the customer dimension table 120c having as the main key the customer identifier 112 of the customer sale history table 110a. The customer dimension table 120c is comprised of a record (or row) including the customer identifier 125 as the main key, a customer name 126, an age 126a, an age 126b, a occupation 126c, an income 126d, and a movie 126e. In the present embodiment, the customer identifier 125 is handled as an identifier associated with the customer identifier 112 of the customer sale history table 110a, and the customer name 126 to movies 126e are handled as attributes.

Next, the table definition processing module 310 generates from the database 10 the region dimension table 120d having as the main key the region code 113 of the customer sale history table 110a. The region dimension table 120d is comprised of one record (or row) including the region code 127 as the main key and the region name 128. In the present embodiment, the region code 127 is handled as an identifier associated with the region code 113 of the customer sale history table 110a, and the region name 128 is handled as an attribute.

Next, the table definition processing module 310 generates from the database 10 the period dimension table 120b having as the main key the period code 114 of the customer sale history table 110a. The period dimension table 120b is comprised of one record (or row) including the period code 123 as the main key and a period 124. In the present embodiment, the period code 123 is handled as an identifier associated with the period code 114 of the customer sale history table 110a, and the period 124 is handled as an attribute.

As described above, the table definition processing module 310 adds identifiers as data to be analyzed and places the identifiers in correspondence with attributes associated therewith. The identifiers and the plurality of dimension tables 120, in which attributes corresponding to the identifiers are stored as rows, are created. The customer sale history table 110a is generated in which the plurality of identifiers corresponding to the identifiers of the plurality of dimension tables and attributes corresponding to the plurality of identifiers are stored as associated with rows.

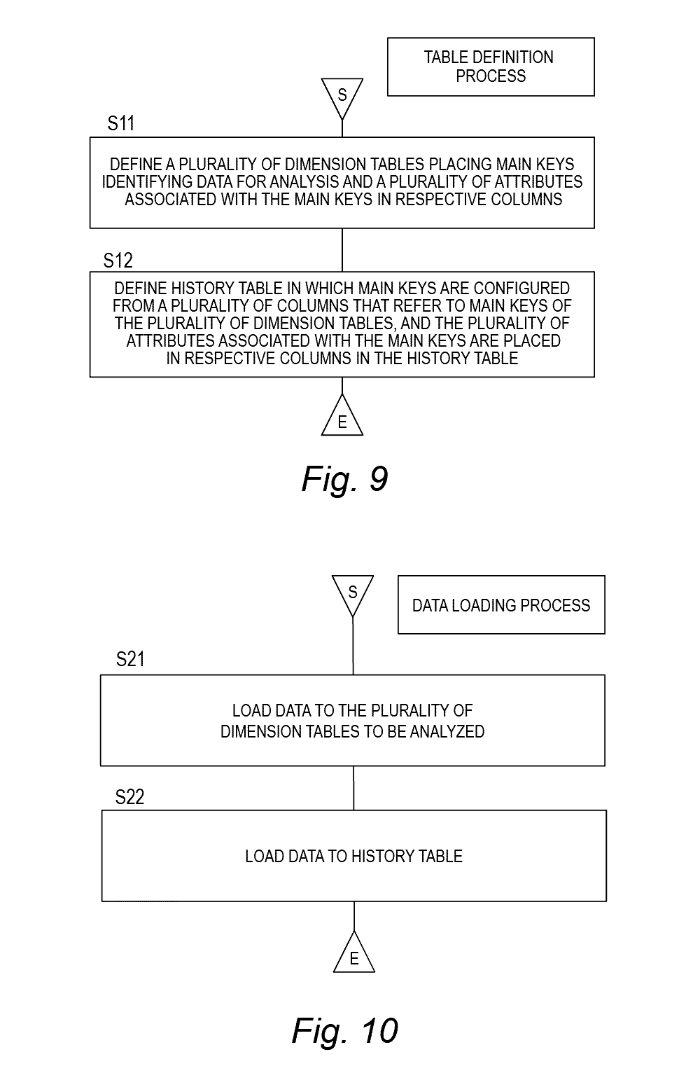

FIG. 9 is a flowchart showing an example of the table definition processing module 310 performed by the data management device 1. This process is executed on the basis of a command by a user of the data management device 1. The data management device 1 starts the process of FIG. 9 after reading in the definition 520 of the star schema 130 shown in FIG. 7.

The data management device 1 defines the plurality of dimension tables 120a to 120d having main keys identifying the data to be analyzed and the plurality of attributes associated with the main keys as respective columns on the basis of the read-in definition 520 (S11).

The data management device 1 configures the main keys from the plurality of columns referring to the main keys of the plurality of dimension tables, and defines the history table 110a having as columns the plurality of attributes associated with the main keys (S12).

By the process above, as shown in FIG. 8, the plurality of dimension tables 120a to 120d indicating the meaning of the database 10 having real world data, and the customer sale history table 11a storing real world data as one-dimensional sequential data are generated.

FIG. 10 is a flowchart showing an example of a process performed by the data loading processing module 320 of the data management device 1. This process is executed after the process shown in FIG. 9 is completed. Alternatively, the process is executed when a user or the like of the data management device 1 issues such a command through the input device 6.

The data loading processing module 320 loads data from the database 10 or the data warehouse 11 to the respective dimension tables 120a to 120d for analysis, which were generated by the table definition processing module 310 (S21).

Next, the data loading processing module 320 loads data from the database 10 to the customer sale history table 110a (fact table 110) for analysis, which was generated by the table definition processing module 310. Then, the data loading processing module 320 loads the column data referring to the main keys of the dimension tables 120a to 120d and attributes associated with these columns as rows in the customer sale history table 110a (S22).

By the processes above, data from the fact table 110 (customer sale history table 110a) of the star schema 130, and the database 10 of the dimension tables 120a to 120d are incorporated.

FIG. 11 shows an example of the clustering results being applied to the data warehouse 11. This process is executed after the process shown in FIG. 9 is completed.

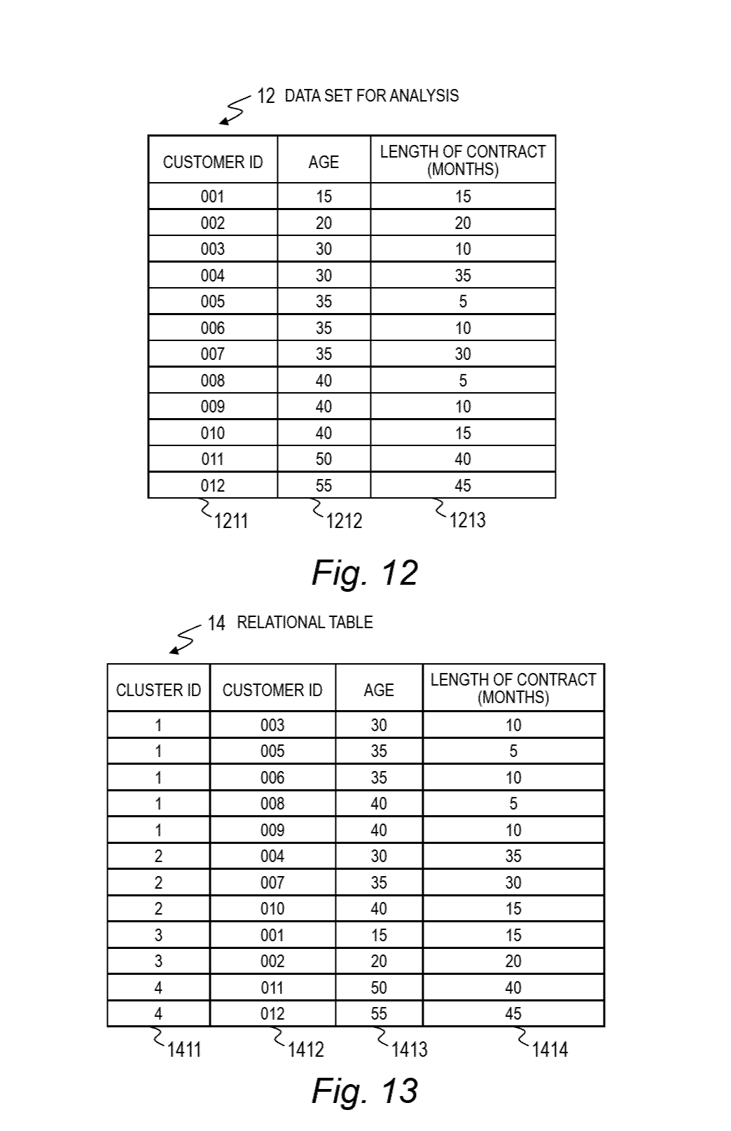

The data mining module 430 performs data mining on the data set for analysis 12 extracted by the data selection module 420 from the data warehouse 11. FIG. 12 shows an example of the data set for analysis 12 selected by the data selection module 420. In this example, the data set for analysis 12 configures one record from the customer ID 1211, age 1212, and length of contract 1213 in months. As for the elements comprising the data set for analysis 12, the user of the data management device 1 selects data from the dimension tables 120a to 120d and the customer sale history table 110a using the input device 6 or the like.

In the example of FIG. 12, the data selection module 420 obtains the customer ID 125 and the age 126b of the customer from the customer dimension table 120c. Next, the data selection module 420 obtains the product identifier 111 corresponding to the customer ID 125 from the customer sale history table 110a and obtains the length of contract 129 in months corresponding to the product identifier 111 from the product dimension table 120a. Then, the data selection module 420 couples the length of contract 129 with the customer ID 125 and age 126b, writes data to the customer ID 1211, age 1212, and length of contract 1213 to generate the data set for analysis 12.

Next, as a result of performing clustering on the data set for analysis 12 using the data mining module 430, the model 13-2 such as shown in FIG. 11 is obtained. After being evaluated by the model evaluation module 440, the literacy applying module 450 converts the model 13 of the clustering results 13-2 to the relational table 14, as described later.

The literacy applying module 450 stores the relational table 14 obtained by conversion from the clustering results 13-2 in the data warehouse 11. The literacy applying module 450 extracts a tree structure from the model 13 of the clustering results 13-2, converts the tree structure to SQL, and performs inquiries on the customer sale history table 110a and the dimension tables 120a to 120d, thereby generating the relational table 14.

The literacy applying module 450 stores the obtained literacy in the data warehouse 11 as the relational table 14, and performs association of the customer sale history table 110a and the dimension tables 120a to 120d. In this manner, it is possible for the business application 340 and the like to perform inquiries on the customer sale history table 110a, the dimension tables 120a to 120d, and the relational table 14 stored in the data warehouse 11.

FIG. 13 shows an example of a relational table 14. The relational table 14 shows an example of one record being comprised of a cluster ID 1411 in which cluster identifiers are stored, a customer ID 1412, age 1413, and a length of contract 1414 in months. The cluster ID 1411 corresponds to the clustering results 13-2, the customer ID 1412 and age 1413 correspond to the customer dimension table 120c, the length of contract 1414 corresponds to the product dimension table 120a, and the customer dimension table 120c and product dimension table 120a are associated with the customer identifier 112 and product identifier 111. The literacy applying module 450 can store in the data warehouse 11 the relations of the dimension tables 120a to 120d and customer sale history table 110a corresponding to respective fields of the relational table 14.

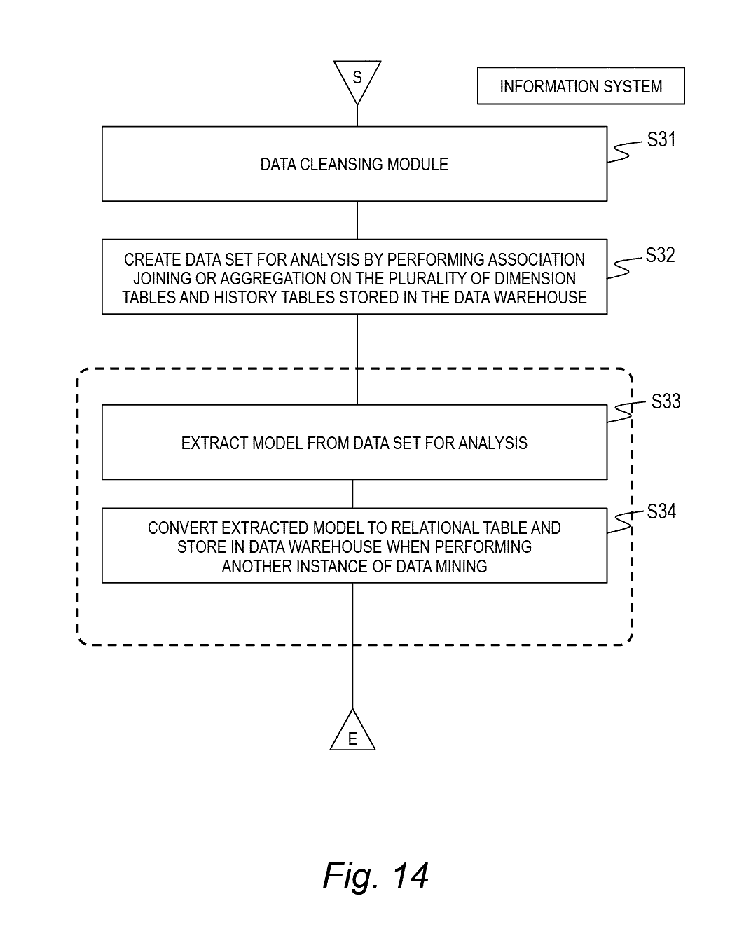

FIG. 14 is a flowchart showing one example of a process performed by the data management device 1 in which the clustering results 13-2 are converted to the relational table 14.

The data cleansing module 410 performs data cleansing on the database 10 used by the business application 340 of the enterprise system (S31). The data cleansing module 410 ensures consistency in the database 10, and the data of the database 10 that has been cleansed is stored in the data warehouse 11.

Next, the data selection module 420 selects data stored in the data warehouse 11 according to the purpose of the data mining, and generates a data set for analysis 12. The data set for analysis 12 is extracted from the data warehouse 11 by the data selection module 420 performing inquiries such as association joining and aggregation on the plurality of dimension tables 120a to 120d and the customer sale history table 110a (fact table 110) including the data for analysis (S32).

The data mining module 430 performs data mining on the data set for analysis 12 and extracts the model 13 (S33). The model 13 is extracted from the data set for analysis 12 as the clustering results 13-2 shown in FIG. 5 and the decision tree 13-1 shown in FIG. 6, for example. When visualizing and evaluating the extracted model 13, the visualization tool determines whether or not the model 13 extracted by evaluation of the model (model evaluation module 440) is new literacy. If the model 13 extracted by the data mining module 430 is obtained as new literacy, then the model evaluation module 440 may be omitted.

The model 13 obtained as new literacy is stored in the data warehouse 11 after the literacy applying module 450 converts the model 13 to the relational table 14 when performing another instance of data mining (S34).

As described above, in the present embodiment, by storing the obtained model 13 in the data warehouse 11 after converting it to the relational table 14, it is possible to perform data mining again by another method.

By converting the obtained model 13 to the relational table 14, it is possible for the data selection module 420 to perform inquiries on the dimension tables 120a to 120d and customer sale history table 110a (fact table 110) generated from the database 10, and the relational table 14 based on the new literacy.

By repeating data mining with different parameters, it is possible to generate the model 13 by trial and error, and it is possible to extract and obtain a new model 13 without relying on human experience or hypothesis. By storing the model 13 in the data warehouse 11 as the relational table 14, it is possible to perform an inquiry thereon and on the star schema 130 as described above.

Data stored in the data warehouse 11 is not limited to data generated by the business application 340, but may be a model obtained by performing data mining on the basis of data generated or aggregated in another computer system or a relational table obtained by conversion from this model.

FIGS. 15 to 19 show an example of the literacy applying module 450 converting a model as new literacy obtained by the data mining module 430 to an SQL model (SQL expression) and the business application 340 using this model as shown in step S3 in FIGS. 2 and 3. Below, an example is described in which the decision tree 13-1 for predicting the attributes of new data is converted by the prediction OLAP analysis 330 to an SQL expression on the basis of a data set for analysis (learned data) 12′ extracted from the data warehouse 11.

FIG. 15 shows an example of the decision tree 13-1 being obtained by extracting the decision tree from the data set for analysis 12′ extracted by the data selection module 420 from the data warehouse 11 as a data mining process.

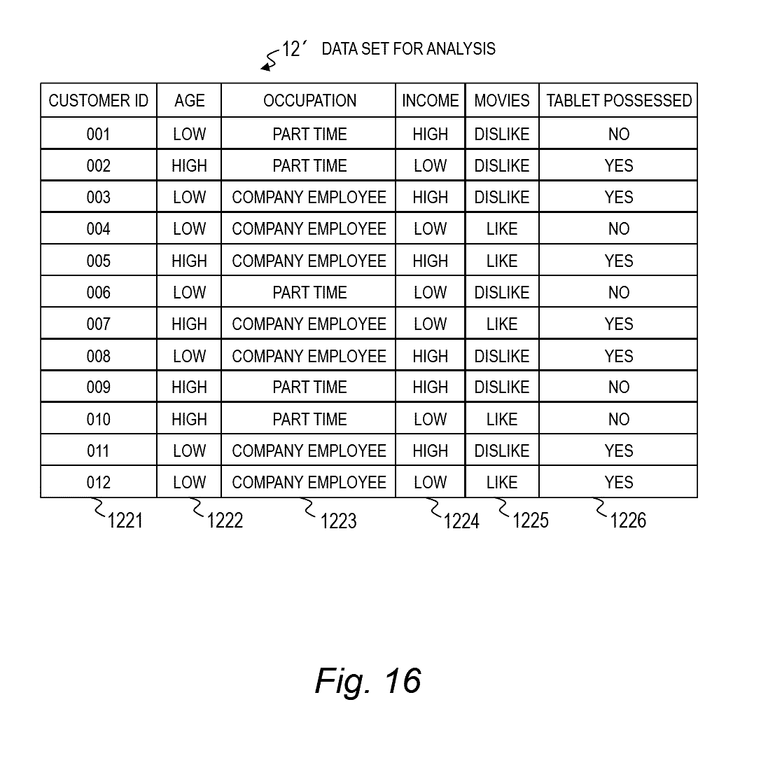

FIG. 16 shows an example of the data set for analysis 12′. The data set for analysis 12′ is comprised of data differing from the data set for analysis 12 shown in FIG. 12. In the example of FIG. 16, the data set for analysis 12′ comprises one record including the customer ID 1221, age 1222, occupation 1223, income 1224, movies 1225 in which the like or dislike of movies is stored, and tablet possession 1226 in which possession or lack thereof of a tablet is stored. As for the elements comprising the data set for analysis 12′, the user of the data management device 1 selects data from the dimension tables 120a to 120d and the customer sale history table 110a using the input device 6 or the like. In this example, the data set for analysis 12′ is generated by the data selection module 420 performing an inquiry on the customer dimension table 120c, the product dimension table 120a, and the customer sale history table 110a. In the data set for analysis 12′, the product identifier 121 of the product dimension table 120a is searched according to the product identifier 111 corresponding to the customer ID 1221, and if a tablet is present among the product names, then the tablet possession 1226 is set to “yes,” and if not, the tablet possession 1226 is set to “no.”

The data mining module 430 extracts the decision tree from the data set for analysis 12′, and obtains the decision tree 13-1 shown in FIG. 15. This decision tree 13-1 is applied to the business application 340 and predicts attributes of new data. In the present embodiment, an example is shown in which the possession or lack thereof of a tablet is predicted as the attribute to be predicted.

The literacy applying module 450 obtains the decision tree 13-1 as a model 13 containing new literacy. The literacy applying module 450 converts the decision tree 13-1 extracted as the data mining results to the relational table 14′.

The literacy applying module 450 converts the decision tree 13-1 to the SQL expression 1310 of the decision tree or the SQL expression 1320 of the decision table shown in FIG. 15 as the relational table 14′. The SQL expression 1320 of the decision table is comprised of one record including the occupation 1321, movies 1322, age 1323, and tablet possession 1324.

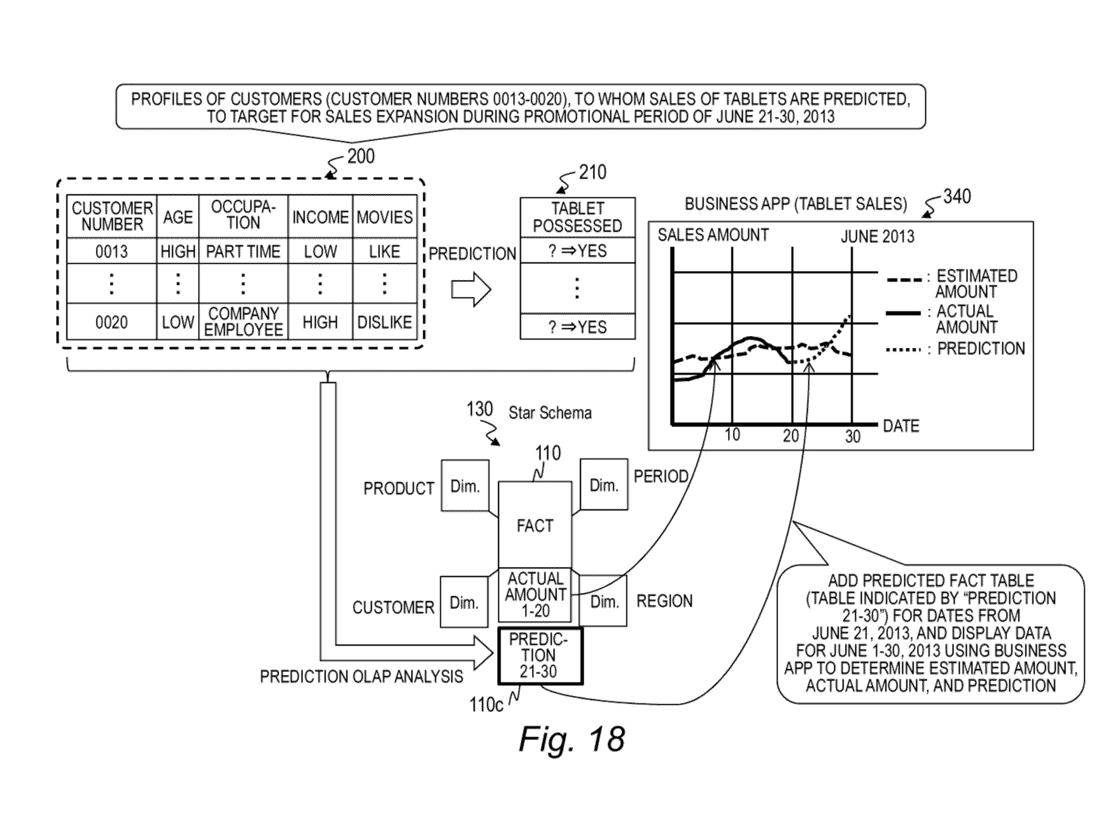

The literacy applying module 450 generates the SQL expression 1310 of a decision tree or the SQL expression 1320 of a decision table from the decision tree 13-1, and combines this with the business application 340 as shown in FIGS. 17 and 18.

FIG. 17 is a schematic view showing an example of a prediction process performed by the data management device 1. The data management device 1 receives new data 100 in which the “tablet possession” column is unspecified. The data management device 1 performs the prediction OLAP analysis 330 on the received data 100, and, referring to the relational table 14′ including the SQL expression 1310 of a decision tree or the SQL expression 1320 of a decision table, determines that “tablet possession” is “yes,” and adds this predicted value to the data 100. Then, the literacy applying module 450 adds data 100′ in which the predicted value has been added to the fact table 110 of the star schema 130 as the prediction fact table 110b.

In this manner, the SQL expression for predicting new data is generated from the decision tree 13-1, and the prediction value for the new data is added to the fact table 110 of the star schema 130, thereby allowing this predicted value to be used by the business application 340 or the like.

FIG. 18 is a descriptive drawing showing another example of a prediction process performed by the data management device 1. FIG. 15 shows an example in which the SQL expression 1310 (SQL model) of the decision tree or the SQL expression 1320 of the decision table obtained as new literacy is used by the business application 340. In this example, the prediction of tablet sales for potential customers is performed using the SQL expression 1310 of the decision tree or the SQL expression 1320 of the decision table obtained as shown in FIG. 15.

In FIG. 18, the fact table 110 of the star schema 130 stores actual sales (“actual amount” in drawing) and the estimate during Jun. 1-20, 2013. The business application 340 reads in the fact table 110 of the star schema 130 and displays tablet sales to the output device 7.

As shown in FIG. 18, the predicted data to be processed is a profile 200 of a potential customer for a tablet. The data management device 1 uses the SQL expression 1310 of the decision tree (or SQL expression 1320 of the decision table) from the profile 200 and predicts possession or lack thereof 210 of a tablet for each customer, and predicts sales value for a tablet to a person who does not own a tablet.

The prediction OLAP analysis 330 of the data management device 1 reads in the profile 200 and predicts the possession or lack thereof 210 of a tablet for each customer using the SQL expression 1310 of the decision tree. Then, the prediction OLAP analysis 330 calculates the sales prediction for Jun. 21-30, 2013 on the basis of the possession or lack thereof 2010 of a tablet, and adds this to the fact table 110 as the fact table 110c. The sales predictions for each day are calculated by separating the profile 200 into the respective days or preparing the profile 200 for each day.

The business application 340 reads in the fact table 110 and the prediction data (prediction 21-30 in drawing) fact table 110c, displays the actual sales of Jun. 1-20, 2013 with a solid line (solid line 1-20 in drawing), displays the estimate of Jun. 1-20, 2013 with a broken line, and displays the predicted value for Jun. 21-30, 2013 with a dotted line.

As described above, by converting the model 13 (decision tree 13-1) obtained from the data set for analysis 12′ in the information system to an SQL expression (SQL model) relational table 14′ and using this in the business application 340, it is possible to provide a method for using new data.

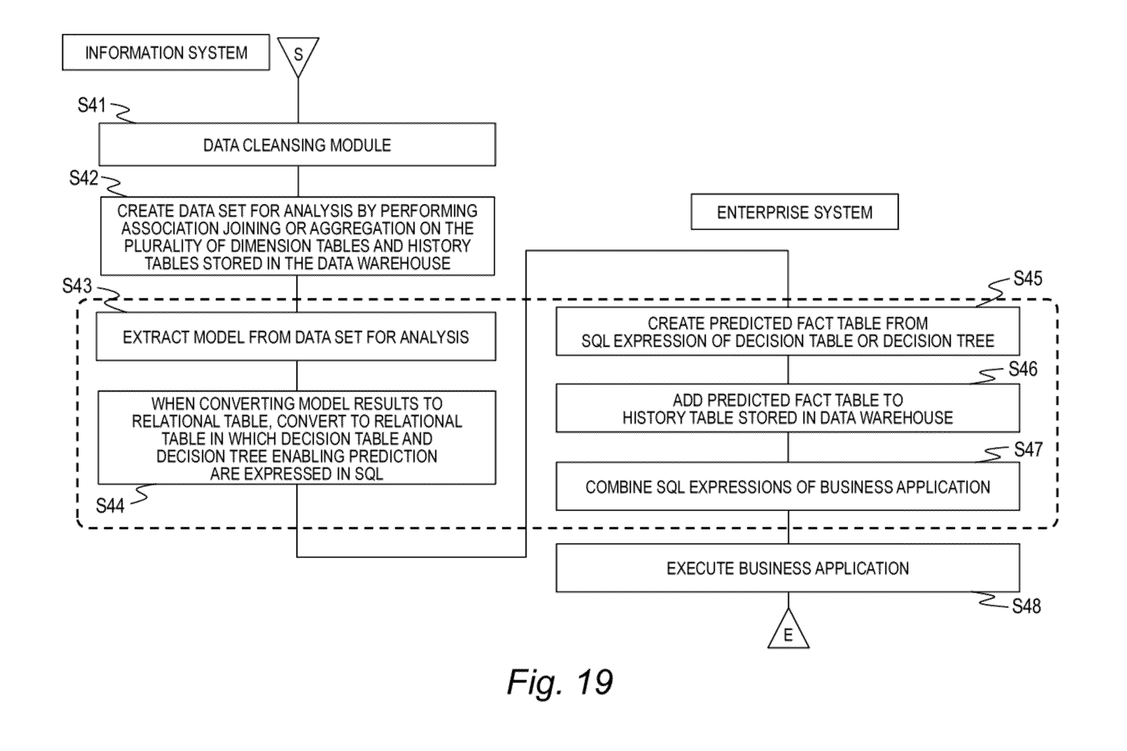

FIG. 19 is a flowchart showing an example of the prediction process performed by the data management device 1.

The data cleansing module 410 performs data cleansing on the database 10 generated by the business application 340 (S41). After data consistency is ensured in the database 10 by the data cleansing module 410, the data is stored in the data warehouse 11.

Next, the data selection module 420 selects data stored in the data warehouse 11, and generates a data set for analysis 12′. The data set for analysis 12′ is extracted from the data warehouse 11 by the data selection module 420 performing inquiries such as association joining and aggregation on the plurality of dimension tables 120a to 120d and the history table 110a (fact table 110) including the data for analysis (S42).

The data mining module 430 performs data mining on the data set for analysis 12′ and extracts the model 13 (S43). The model 13 is extracted from the data set for analysis 12′ as the decision tree 13-1 shown in FIG. 6, for example. If the model 13 extracted by the data mining module 430 is obtained as new literacy as is, then the model evaluation module 440 may be omitted.

Next, the data management device 1 converts the model 13 obtained as new literacy to the relational table 14′ (S44). At this time, as shown in FIG. 15, the literacy applying module 450 converts the model 13 into the relational table 14′ comprised of the SQL expression (or predicate expression) 1310 of a decision tree or the SQL expression 1320 enabling prediction.

Next, when the prediction OLAP analysis 330 receives new data, it uses the SQL expression 1310 of the decision tree or the SQL expression 1320 of the decision table, and generates the predicted results as the new fact table 110c (S45). The prediction OLAP ANALYSIS 330 adds the newly generated fact table 110c to the customer sale history table 110a stored in the data warehouse 11 (S46).

Next, the literacy applying module 450 combines the SQL expression 1310 of the obtained decision tree or the SQL expression of the decision table with the business application 340 (S47). Then, by executing the business application 340 (S48), it is possible to use the newly added fact table 110c together with the existing fact table 110.

As described above, the model 13 extracted from the data set for analysis 12 by the data mining module 430 is converted to the relational table 14′ comprised of the SQL expression 1310 of the decision tree or the SQL expression 1320 of the decision table 1320 predicting new data. Then, using the data predicted by the SQL expression 1310 of the decision tree or the SQL expression 1320 of the decision table, the new fact table 110c is added to the existing fact table 110. By combining the SQL expression 1310 of the decision tree or the SQL expression 1320 of the decision table with the business application 340, it is possible to use the existing fact table 110 to which the new fact table 110c was added. In other words, by predicting data attributes using the SQL expression 1310 of the decision tree or the SQL expression 1320 of the decision table and providing the predicted results to the business application 340, it is possible to use the new model 13 without adding modifications to the existing business application 340.

As described above, in the present embodiment, literacy obtained by the data mining module 430, or in other words, the model 13 such as the decision tree 13-1 and the clustering results 13-2 can be combined with the SQL data model of the business application 340 of the enterprise system. Also, by storing the relational table converted from the obtained model 13 in the data warehouse 11, it is possible to perform data mining again by another method. In other words, the model 13 comprised of the decision tree 13-1 and the clustering results 13-2 is converted to an SQL model and expressed as the relational table 14 (or 14′), thereby enabling inquiry of the fact table 110 and the dimension tables 120a to 120d of the data warehouse 11.

The inquiry process on the relational table 14′ of the obtained model 13 can be executed without modifying the existing business application 340. Also, by repeatedly performing analysis and evaluation on the same data set for analysis 12 (12′) while changing categories and types and with differing setting parameters, it is possible to extract a new model 13 by trial and error. In particular, by repeating analysis and evaluation on a large quantity of data with differing setting parameters, it is possible to extract new literacy, or in other words, new models 13 without reliance on human experience or hypothesis, and to apply this information to the business application 340.

Also, in the embodiment above, a decision tree and clustering were described as methods for data mining, but another method such as association rule extraction and the like can be used, for example. In the case of association rule extraction, significant rules among a plurality of data items are discovered while focusing on data items appearing simultaneously. These rules can be expressed as “CASE-WHEN-THEN-” in a manner similar to the SQL expression (SQL expression 1310 of the decision tree shown in FIGS. 15 and 17) of the decision tree in the embodiment. In other words, by association rule extraction, it is possible to apply the association rule SQL expression (CASE˜WHEN˜THEN˜) to the relational table 14 (relational table 14 shown in FIGS. 3 and 4). In this manner, it is possible to recommend products to be bought simultaneously on the basis of the association rule extraction in a manner similar to the product recommendation using the decision tree shown in FIG. 6. Furthermore, by applying the SQL expression (CASE˜WHEN˜THEN˜) to the relational table 14 using another statistical analysis method such as regression analysis or discriminant analysis, this method can similarly be used.

Also, in the embodiment above, an example was shown in which the business application 340 managing the database 10, the data warehouse 11, and the literacy extraction system 30 are all provided on the same computer, but these may be provided in separate computers. For example, a configuration may be adopted in which the business application 340 and the database 10 are provided on a business server and the data warehouse 11 and the literacy extraction system 30 are provided on an analysis server.

Also, in the present embodiment, an example was shown in which the data management device is comprised of a calculator including an auxiliary storage device 4, but a configuration may be adopted in which the data management device 1 and the auxiliary storage device are connected through a network.

The computers, processing units, and processing means described related to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

What is claimed is:

1. A data management method using results of analyzing data stored in a storage module by a computer comprising a processor and the storage module, the data management method comprising:
a first step of selecting, by the computer, data stored in the storage module, and generating, a data set for analysis;
a second step of performing, by the computer, prescribed data mining on the data set for analysis, and extracting, a model from the data set for analysis;
a third step of converting, by the computer, the model to a relational table; and
a fourth step of associating, by the computer, with a dimension table and a history table stored in advance in the storage module in association with the relational table.

2. The data management method according to claim 1, wherein, in the second step, either a decision tree or clustering is executed as the data mining, and the model is extracted from the decision tree and clustering results.

3. The data management method according to claim 2,
wherein, in the clustering, specific attributes of the data set for analysis are separated into clusters on the basis of distances between data points, and
wherein, in the third step, a tree structure is converted to SQL on the basis of results of separating the data points into clusters to generate the relational table.

4. The data management method according to claim 2,
wherein the decision tree extracts a model that can predict specific attributes of the data set for analysis, and
wherein, in the third step, the model that can predict the specific attributes is converted either to an SQL expression of a decision table or an SQL expression of a decision tree to generate the relational table.

5. The data management method according to claim 4, further comprising:
a fifth step of receiving new data, predicting attributes of the data using the relational table, and providing results of the prediction to a business application.

6. The data management method according to claim 1, further comprising:
a sixth step of selecting whether to store the relational table in the storage module and use the relational table as data of the data set for analysis, or to use the relational table in a business application.

7. A data management device that uses results of analyzing data stored in the storage module, the data management device comprising:
a processor;
the storage module;
a data selection module that selects data stored in the storage module and generates a data set for analysis;
a data mining module that performs prescribed data mining on the data set for analysis and extracts a model from the data set for analysis; and
a literacy applying module that converts the model to a relational table and places a dimension table and a history table stored in advance in the storage module in association with the relational table.

8. The data management device according to claim 7, wherein the data mining module executes either a decision tree or clustering as said data mining, and extracts the model from the decision tree and clustering results.

9. The data management device according to claim 8,
wherein, in the clustering, specific attributes of the data set for analysis are separated into clusters on the basis of distances between data points, and
wherein the literacy applying module converts a tree structure to SQL on the basis of results of separating the data points into clusters to generate the relational table.

10. The data management device according to claim 8,
wherein the decision tree extracts a model that can predict specific attributes of the data set for analysis, and
wherein the literacy applying module converts the model that can predict the specific attributes either to an SQL expression of a decision table or an SQL expression of a decision tree to generate the relational table.

11. The data management device according to claim 10, further comprising:
a prediction analysis module that receives new data, predicts attributes of the data using the relational table, and provides results of the prediction to a business application.

12. The data management device according to claim 7, further comprising:
an evaluation module that selects whether to store the relational table in the storage module and use the relational table as data of the data set for analysis, or to use the relational table in a business application.

13. A non-transitory computer-readable storage medium storing a program that causes a computer to use results of analyzing data stored in a storage module, the computer comprising a processor and the storage module, the storage medium causing the computer to execute:
a first step of selecting data stored in the storage module and generating a data set for analysis;
a second step of performing prescribed data mining on the data set for analysis and extracting a model from the data set for analysis;
a third step of converting the model to a relational table; and
a fourth step of placing a dimension table and a history table stored in advance in the storage module in association with the relational table.

14. The storage medium according to claim 13, wherein, in the second step, either a decision tree or clustering is executed as said data mining, and the model is extracted from the decision tree and clustering results.

15. The storage medium according to claim 14,
wherein, in said clustering, specific attributes of the data set for analysis are separated into clusters on the basis of distances between data points, and
wherein, in the third step, a tree structure is converted to SQL on the basis of results of separating the data points into clusters to generate a relational table.
